(19) United States
(12) Patent Application Publication
(10) Pub. No.: US 2023/0020984 A1
(43) Pub. Date: Jan. 19, 2023

(54) GRILL PAN FOR DIRECT FIRED ROAST

(71) Applicants: JUNG WOOK KIM, Daegu (KR); TAE SUCK KIM, Daegu (KR)

(72) Inventors: JUNG WOOK KIM, Daegu (KR); TAE SUCK KIM, Daegu (KR)

(21) Appl. No.: 17/740,564

(22) Filed: May 10, 2022

(30) Foreign Application Priority Data
Jul. 14, 2021 (KR) 10-2021-0092178

(51) Int. Cl. A47J 27/022; A47J 37/10

(52) U.S. Cl. CPC A47J 27/022; A47J 37/108

(57) ABSTRACT

Provided is a grill pan for a direct fired roast, capable of reducing heat conduction to an oil collecting part through a roasting plate, and fundamentally preventing oil from being burned in the oil collecting part. The grill pan includes an integrated roasting plate (300) including a disc part (310) having a ring shape, a reinforcing plate (320) connected to as inner surface of the disc part across a center of the disc part having the ring shape, a plurality of upper ribs (330) spaced apart from each other at a predetermined interval such that both ends of the per rib are connected to the inner surface of the disc part, and a plurality of lower ribs (340) in which the lower rib is provided between the upper ribs such that both ends of the lower rib are connected to the inner surface of the disc part.

### BACKGROUND OF THE INVENTION

### 1. Field of the Invention

The present invention relates to a grill pan for a direct fired roast, and more particularly, to a grill pan for a direct fired roast, which is used for roasting meat or fish in a direct firing scheme.

### 2. Description of the Related Art

In general, a scheme of roasting meat or fish may be classified into a direct firing scheme in which a fire of a heating means such as a gas stove or a charcoal fire makes direct contact with the meat or the fish to roast the meat or the fish, and an indirect heating scheme in which the fire does not make direct contact with the meat or the fish to roast the meat or the fish.

The present invention relates to a direct firing scheme, and one example of a conventional grill pan for a direct fired roast, which is used in the direct firing scheme, is disclosed in the registration publication of Korean Patent Registration No. 10-2214329 that has been filed and registered by the inventor of the present invention.

As shown in FIGS. 1, 2, and 3, a grill, pan 100 for a direct fired roast, which is disclosed in the registration publication of Korean Patent Registration No. 10-2214329, includes a side wall 101 extending upwards in a curved shape, and a bottom surface 104 of a grill pan main body surrounded by the side wall. The bottom surface 104 of the grill pan main body includes an oil collecting part 102 concavely foamed in the bottom surface 104 of the grill pan main body along a lower end of the side wall 101.

In addition, the bottom surface 104 of the grill pan main body includes: a plurality of lower rips 112 surrounded by the oil collecting part 102, each formed at a top surface thereof with a first oil passage 112c (lower oil passage) connected to the oil collecting part, and spaced apart from each other at a predetermined interval; and a plurality of upper ribs 174 located higher than the lower ribs 112, surrounded by the oil collecting part 102, each formed at a top surface thereof with a second oil passage 114c (upper oil passage) connected to the oil collecting part, and spaced apart from each other at a predetermined interval such that one edge 114a of the upper rib 114 overlaps an inner portion of one lower rib 112, and an opposite edge 114b of the upper rib 114 overlaps an inner portion of another adjacent lower rib 112 when viewed in a plan view.

A slot 116 (heat outlet) is formed between a lower portion of the upper rib 114 and an upper portion of the lower rib to discharge heat, in which oil discharged from meat flows into the oil collecting part 102 through the first oil passage 112c (lower oil passage) and the second oil passage 114c (upper oil passage).

Each of the first oil passage 112c (lower oil passage) and the second oil passage 114c (upper oil passage) has a gradient that is gradually lowered from a longitudinal center portion thereof toward the oil collecting part 102 to allow the oil to flow into the oil collecting part.

According to the conventional grill pan 100 for the direct fired roast configured as described above, since heat rising through the slot 116 formed between the lower rib 112 and the upper rib 114 makes direct contact with the meat placed on the top surface of the upper rib 114, the meat may be roasted in the direct firing scheme.

In addition, since the upper ribs 114 and the lower ribs 112 are alternately arranged in an up-down dual structure to allow ends thereof to overlap each other, the oil of the meat falling toward the lower rib 112 through the slot 116 may be safely received so as to be guided to the oil collecting part 102.

However, according to the conventional grill pan 100 for the direct fired roast configured as described above, in a case of roasting beef or fish with low fat, a small amount of oil flows into the c1 collecting part 102, which does not cause a big problem, whereas in a case of roasting pork or the like with high fat, a large amount of oil flows into the oil collecting part 102, so that the oil collecting part may overflow with the oil.

In particular, since the lower rib 112 and the upper rib 114 of the grill pan 100 for the direct fired roast is formed of aluminum, an aluminum alloy, or the like having high thermal conductivity, heat having a high temperature may be easily conducted to the oil collecting part 102 integrally connected to the lower rib 112 and the upper rib 114 by a fire applied to the lower rib 112 and the upper rib 114, so that the oil in the oil collecting part 102 may be dispersed or burned by the heat to generate smoke and soot.

In order to solve the above problems, a flat plate portion on which the lower rib 112 and the upper rib 114 are formed may be separated from the oil collecting part 102 formed on an edge. In this case, however, since an edge portion that supports the lower rib 112 and the upper rib 114 is thin, defects may be easily caused in a process of processing the lower rib 112 and the upper rib 114, so that a manufacturing yield of a product may be significantly reduced.

In addition, even when a direct-firing flat roasting plate including the lower rib 112 and the upper rib 114 is normally processed, there may be a structural problem that an arrangement structure of the lower rib 112 and the upper rib 114 is deformed or twisted by the fire during use.

### DOCUMENTS OF RELATED ART

### Patent Documents

(Patent document 1) Korean Patent Registration No. 10-2214329

### SUMMARY OF THE INVENTION

To solve the problems described above, an object of the present invention is to provide a grill pan for a direct fired roast, in which deformation or twisting may not be caused even when a roasting plate that is suitable for a direct fired roast, facilitates collection of oil, and includes upper and lower ribs has a circular flat plate shape.

Another object of the present invention is to provide a ill pan for a direct fired roast, including a roasting plate that is suitable for a direct fired roast, facilitates collection of oil, and includes upper and lower ribs, and a support container including a support on which the roasting plate is placed and supported and an oil collecting part for collecting oil discharged from the upper and lower ribs of the roasting plate.

Still another object of the present invention is to provide a grill pan for a direct fired roast, capable of reducing heat conduction to an oil collecting part through a roasting plate, and fundamentally preventing oil from being burned in the oil collecting part.

Yet another object of the present invention is to provide a structure capable of manufacturing a roasting plate that is suitable for a direct fired roast and facilitates collection of oil with a high yield.

To achieve the objects described above, according to the present invention, there is provided a grill pan for a direct fired roast, including: an integrated roasting plate including a disc part having a ring shape, a reinforcing plate connected to an inner surface of the disc part across a center of the disc part having the ring shape, a plurality of upper ribs connected to one side and an opposite side of the reinforcing plate to form a right angle with the one side and the opposite side of the reinforcing plate, and spaced apart from each other at a predetermined interval such that both ends of the upper rib are connected to the inner surface of the disc part, and

a plurality of lower ribs connected to the one side and the opposite side of the reinforcing plate to form a right angle with the one side and the opposite side of the reinforcing plate, in which the lower rib is provided between the upper ribs such that both ends of the lower rib are connected to the inner surface of the disc part,

in which a U-shaped oil passage is formed in each of the upper and lower ribs,

both edges of each of the upper ribs extend to outer sides of edges of adjacent lower ribs so that the edges of the upper and lower ribs vertically overlap each other at a predetermined interval,

an uppermost end surface of the reinforcing plate is at least located lower than a position of an uppermost end surface of the upper rib, and the U-shaped oil passage formed in each of the upper and lower ribs is connected to the reinforcing plate on a same plane as the reinforcing plate; and

a support container including a support on which the roasting plate is placed and supported, and an of collecting part for collecting oil discharged from the upper and lower ribs of the roasting plate.

In addition, a lowermost surface of the reinforcing plate may be located identical to a position of a lowermost surface of the lower rib.

In addition, the U-shaped oil passage formed in each of the upper and lower ribs may have a gradient that is gradually lowered from the reinforcing plate toward the disc part.

In addition, the reinforcing plate may be curved along a pattern of the upper and lower ribs.

According to the present invention, the grill pan for the direct fired roast includes a roasting plate including a disc part having a ring shape, a reinforcing plate connected to an inner surface of the disc part across a center of the disc part having the ring shape, a plurality of upper ribs connected to one side and an opposite side of the reinforcing plate to form a right angle with the one side and the opposite side of the reinforcing plate, and spaced apart from each other at a predetermined interval such that both ends of the upper rib are connected to the inner surface of the disc part, and a plurality of lower ribs connected to the one side and the opposite side of the reinforcing plate to form a right angle with the one side and the opposite side of the reinforcing plate, in which the lower rib is provided between the upper ribs such that both ends of the lower rib are connected to the inner surface of the disc part, in which, in particular, a U-shaped oil passage is formed in each of the upper and lower ribs,

both edges of each of the upper ribs extend to outer sides of edges of adjacent lower ribs so that the edges of the upper and lower ribs vertically overlap each other at a predetermined interval,

an uppermost end surface of the reinforcing plate is at least located lower than a position of an uppermost end surface of the upper rib, and the U-shaped oil passage formed in each of the upper and lower ribs is connected to the reinforcing plate on a same plane as the reinforcing plate, so that deformation or twisting of the upper and lower ribs can be prevented during a manufacturing process or use of the roasting plate.

In addition, heat conduction to the oil collecting part, which is separated from the roasting plate, through the roasting plate can be reduced, and the oil can be prevented from being burned in the oil collecting part.

In addition, the grill pan for the direct fired roast can be used effectively and efficiently for a direct fired roast of beef, pork, and fish.

### BRIEF DESCRIPTION OF THE DRAWINGS

FIG. 1 is a perspective view showing a conventional grill pan for a direct fired roast.

FIG. 2 is a sectional view taken along line III-III of FIG. 1.

FIG. 3 is an enlarged sectional view showing portions of upper and lower ribs of FIG. 2.

FIG. 4 is a perspective view showing a coupling structure of a grill pan for a direct fired roast according to the present invention.

FIG. 5 is a plan view showing a roasting plate constituting the grill pan for the direct fired roast according to the present invention.

FIG. 6 is a side view showing the roasting plate according to the present invention when viewed in a longitudinal direction of a reinforcing plate.

FIG. 7 is a side view showing the roasting plate according to the present invention when viewed in a direction orthogonal to the reinforcing plate.

FIG. 8 is a sectional view taken along line A-A of FIG. 5.

FIG. 9 is a sectional view taken along line B-B of FIG. 5

FIG. 10 is an enlarged sectional view showing a portion of FIG. 9.

FIG. 11 is a sectional view taken along line C-C of FIG. 5.

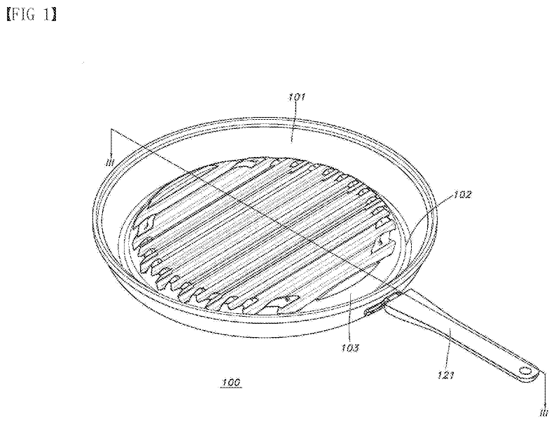

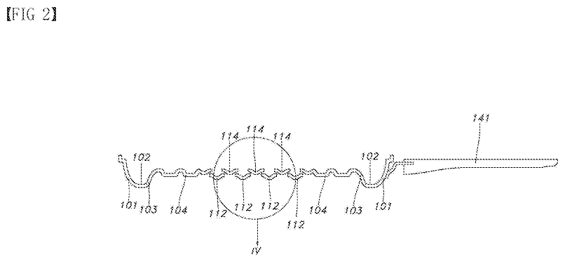

### DETAILED DESCRIPTION OF THE INVENTION

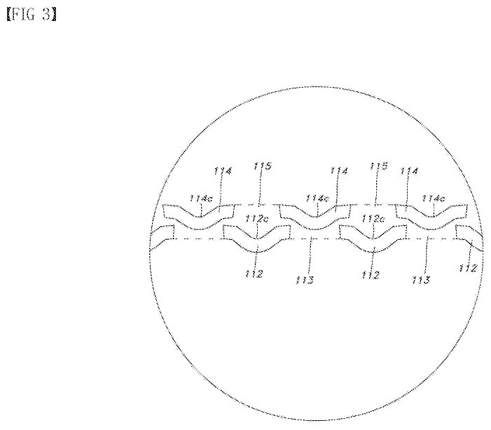

Hereinafter, a technical configuration and operational effects of a grill pan 200 for a direct fired roast according to the present invention will be described in detail with reference to FIGS. 4 to 11.

According to the present invention, as shown in FIG. 4, the grill pan 200 for the direct fired roast may include a roasting plate 300 formed of aluminum or the like, and a support container 350 formed of an aluminum alloy, stainless steel, or the like.

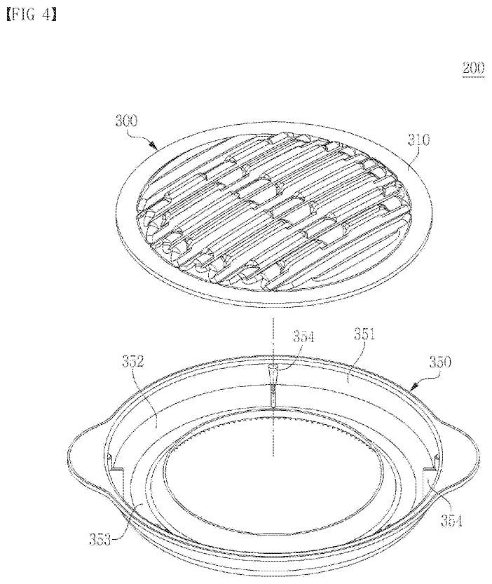

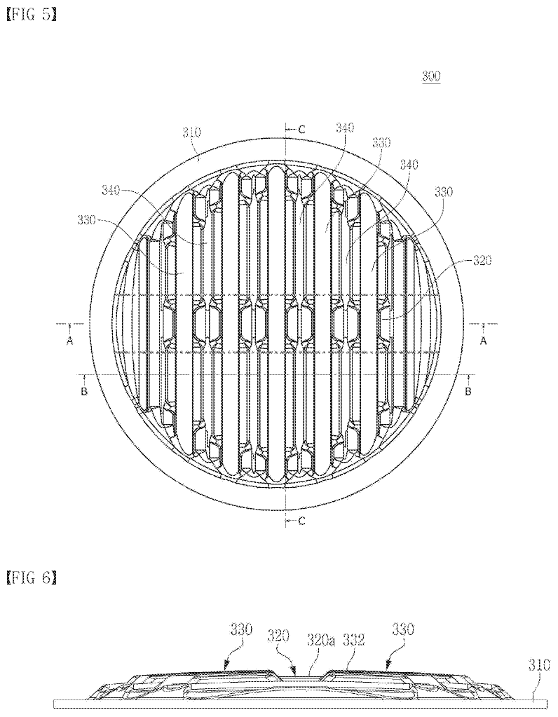

According to the present invention, as shown in FIGS. 4 and 5, the roasting plate 300 may include: a disc part 310 having a ring shape; and a reinforcing plate 320 having both ends connected to an inner surface of the disc part across a center of the disc part having the ring shape. The reinforcing plate 320 may be formed integrally with the ring-shaped disc part 310, and formed in a portion indicated by a dotted line in FIG. 5.

In addition, the roasting plate 300 may include: a plurality of upper ribs 330 connected to one side and an opposite side of the reinforcing plate to form a right angle with the one side and the opposite side of the reinforcing plate, and spaced apart from each other at a predetermined interval such that both ends of the upper rib are connected to the inner surface of the disc part; and a plurality of lower ribs 340 connected to the one side and the opposite side of the reinforcing plate to form a right angle with the one side and the opposite side of the reinforcing plate, in which the lower rib is provided between the upper ribs such that both ends of the lower rib are connected to the inner surface of the disc part.

The upper ribs 330 and the lower ribs 340 may also be integrally formed when the reinforcing plate 320 and the ring-shaped disc part 310 are formed.

A ring width of the ring-shaped disc part 310 may be, for example, 30 to 40 mm, and an outer diameter of a ring may be 250 to 350 mm.

As shown in FIGS. 5, 8, and 11, the reinforcing plate 320 may have the both ends integrally connected to the inner surface of the disc part across the center of the ring-shaped disc part 310, and a width of the reinforcing plate may be approximately 10% to 20% of the outer diameter of the disc part 310. When the width of the reinforcing plate is too wide, direct fired roast efficiency may be reduced, and when the width of the reinforcing plate is too narrow, supporting strength for maintaining shapes of the upper ribs 330 and the lower ribs 340 on both sides of the reinforcing plate may be reduced during a manufacturing process of the roasting plate or during use of the roasting plate after being manufactured.

In addition, the upper ribs 330 may be spaced apart from each other at a predetermined interval to form a straight line in a direction traversing the reinforcing plate with the reinforcing plate 320 interposed therebetween, and the lower ribs 340 formed between the upper ribs 330 may form a straight line in the direction traversing the reinforcing plate 320 with the reinforcing plate 320 interposed therebetween.

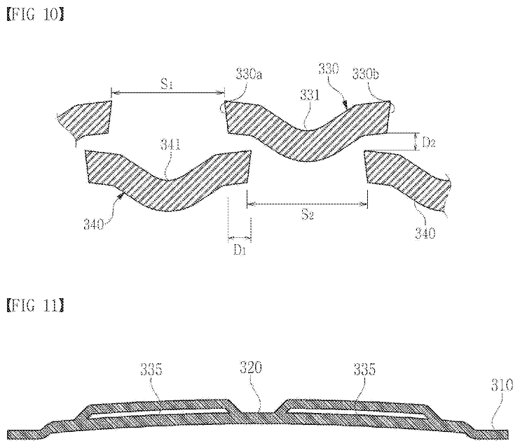

As shown in FIGS. 9 and 10, the upper ribs 330 may be separated from each other by spaces S1 formed at a predetermined interval, and the lower ribs 340 may be separated from each other under the upper ribs 330 by spaces S2 formed at a predetermined interval and having a width that is smaller than a width of the upper rib. The space S1 of the upper rib 330 may have a width that is smaller than a width of the lower rib.

In other words, each of the lower ribs 340 may be located under the space S1 of the upper rib 330, and each of the upper ribs 330 may be alternately located over the space S2 of the lower rib 340.

The upper rib 330 and the lower rib 340 may be formed in top surfaces thereof with an upper oil passage 331 and a lower oil passage 341 having a U-shaped section, respectively.

The upper oil passage 331 and the lower oil passage 341 may serve as passages for discharging oil toward the support container 350.

In addition, as shown in FIG. 10, the upper rib 330 located over a lower space S2 of the lower rib 340 may have one edge 330a that, partially overlaps a lower rib when viewed in a plan view, and an opposite edge 330b that partially overlaps another adjacent lower rib across the lower space S2 of the lower rib 340 by a width D1. This configuration is provided to receive, when oil that comes out from meat or the like placed and roasted on the upper rib 330 falls on outer sides of the both edges 330a and 330b without being fully recovered to the upper oil passage 331 formed in the top surface of the upper rib 330, the oil by the lower rib 340 so that the oil may smoothly flow toward the support container through the lower oil passage 341.

In addition, a space gap D2 communicating with the lower space S2 may be formed between the upper rib 330 and the lower rib 340.

As shown in FIG. 11, the space gap D2 may form a slot-shaped groove 335 in a longitudinal direction of the upper rib 330 and the lower rib 340 with the reinforcing plate 320 interposed therebetween.

The slot-shaped groove 335 may serve to induce heat rising through the lower space S2 to exit the slot-shaped groove 335 and rise upward through an upper space S1.

As the heat rising through the lower space S2 exits the slot-shaped groove 335 and rises upward through the upper space S1 as described above, the heat may make direct contact with a surface of the meat placed on the upper rib 330, so that the meat may be directly fired and roasted.

The upper rib 330 and the lower rib 340 may be alternately arranged in an up-down dual structure, and the width of the lower rib 340 may be wider than a width of the upper space S1 so that all of the oil falling down through the upper space S1 may be received by the lower rib 340.

In addition, a width of the oil passage 341 formed in the top surface of the lower rib 340 may be slightly wider than a horizontal width of the upper space S1.

Since the upper rib 330 and The lower rib 340 are configured as described above, the oil may be prevented from falling down to contaminate surrounding containers or from falling directly into the fire to generate smoke and soot, and the fire supplied from a heating means such as a gas stove or a charcoal fire may make direct contact with the meat placed on the top surface of the upper rib 330, so that efficiency and flavor of the direct fired roast may be doubled.

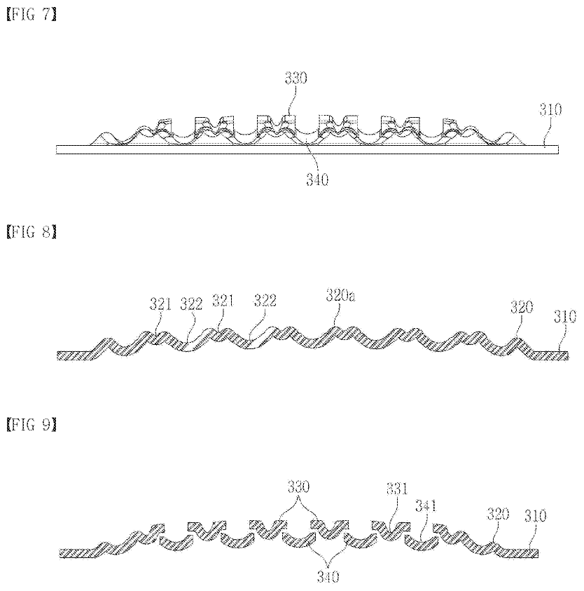

In addition, as shown in FIGS. 6 and 8, an uppermost end surface 320a of the reinforcing plate may be at least located lower than a position of an uppermost end surface 332 of the upper rib 330.

The upper oil passages 321 of the reinforcing plate alternately arranged in the reinforcing plate 320 may be connected to the U-shaped oil passage 331 formed in the upper rib 330 to form a straight line on a same plane as the U-shaped oil passage 331 formed in the upper rib 330, and the lower oil passages 322 of the reinforcing plate alternately arranged in the reinforcing plate 320 may be connected to the U-shaped oil passage 341 formed in the lower rib 340 to form a straight line on a same plane as the U-shaped oil passage 341 formed in the lower rib 340.

The reinforcing plate 320 configured as described above may serve to support the upper and lower ribs 330 and 340 to prevent the upper and lower ribs 330 and 340 from being deformed or twisted during the manufacturing process or the use of the roasting plate 300, and may serve to connect the U-shaped oil passages 331 and 341 of the upper and lower ribs 330 and 340 to each other so as to prevent the oil from stagnating on a surface of the reinforcing plate 320. The upper rib 330 and the lower rib 340 having the U-shaped oil passages with the reinforcing plate 320 interposed therebetween may be inclined to have a gradient that is gradually lowered from a center to both ends of the reinforcing plate.

It should be understood that the disc part 310, the reinforcing plate 320, the upper rib 330, and the lower rib 340 described above are used for convenience of describing a structure of the present invention, and the disc part 310, the reinforcing plate 320, the upper rib 330, and the lower rib 340 may be integrally manufactured by using aluminum or an aluminum alloy plate during the manufacturing process.

In particular, according to the present invention, the reinforcing plate 320 may be curved along a pattern of the upper and lower ribs 330 and 340 at a position lower than the position of the uppermost end surface 332 of the upper rib 330 as shown in FIG. 8, so that even when a raw material of the roasting plate 300 with a thin thickness is processed, strength of the roasting plate may be significantly improved.

Meanwhile, as shown in FIG. 4, the support container 350 on which the roasting plate 300 is placed and supported may include: a stepped sill part 352 stepped with respect to a side wall 351; and an oil collecting part 353 for collecting oil discharged from the upper and lower ribs of the roasting plate. The oil collecting part 353 may be concavely formed along an inner bottom surface of the container surrounded by the side wall 351.

A center portion of the container surrounded by the side wall 351 may be opened so as to be exposed to the reinforcing plate 320 and the upper and lower ribs 330 and 340 of the roasting plate, and the fire may be supplied to the roasting plate 300 through the opened portion.

A plurality of supports 354 on which the ring-shaped disc part 310 of the roasting plate 300 as placed and supported may protrude from the stepped sill part 352. The support 354 may allow the roasting plate 300 to maintain a sufficient interval from the oil collecting part 353 when the roasting plate 300 is placed on the support 354, and may allow the roasting plate 300 to be easily separated from the support container.

According to the present invention, since the support container 350 is configured such that the oil collected through the upper and lower ribs 330 and 340 may flow down to the oil collecting part 353 through the ring-shaped disc part 310 when The ring-shaped disc part 310 of the roasting plate 300 is placed on the support 354, exposure of the oil to the fire may be minimized, so that the oil may be safely discharged.

The grill pan 200 for the direct fired roast according to the present invention described above is not limited to the structures of the drawings and the descriptions as illustrated above, and may be implemented with various modifications within the scopes of the claims and the objects of the present invention.

What is claimed is:

1. A grill pan for a direct fired roast, comprising an integrated roasting plate, wherein the roasting plate includes:
a disc part having a ring shape;
a reinforcing plate connected to an inner surface of the disc part across a center of the disc part haying the ring shape, and including upper and lower oil passages that are alternately arranged;
a plurality of upper ribs connected to one side and an opposite side of the reinforcing plate to form a right angle with the one side and the opposite side of the reinforcing plate, and spaced apart from each other at a predetermined interval such that both ends of the upper rib are connected to the inner surface of the disc part; and
a plurality of lower ribs connected to the one side and the opposite side of the reinforcing plate to form a right angle with the one side and the opposite side of the reinforcing plate, in which the lower rib is provided between the upper ribs such that both ends of the lower rib are connected to the inner surface of the disc part,
a U-shaped oil passage is formed in each of the upper and lower ribs,
both edges of each of the upper ribs extend to outer sides of edges of adjacent lower ribs so that the edges of the upper and lower ribs vertically overlap each other at a predetermined interval,
an uppermost end surface of the reinforcing plate is located lower than a position of an uppermost end surface of the upper rib,
the U-shaped oil passage formed in the upper rib is connected to the upper oil passage formed in the reinforcing plate to form a straight line on a same plane as the upper oil passage, and
the U-shaped oil passage formed in the lower rib is connected to the lower oil passage formed in the reinforcing plate to form a straight line on a same plane as the lower oil passage.

2. The grill pan of claim 1, wherein a lowermost surface of the reinforcing plate is located identical to a position of a lowermost surface of the lower rib.

3. The grill pan of claim 1, wherein the U-shaped oil passage formed in each of the upper and lower ribs has a gradient that is gradually lowered from the reinforcing plate toward the disc part.

4. The grill pan of claim 1, wherein the reinforcing plate is curved along a pattern of the upper and lower ribs.

5. The grill pan of claim 1, further comprising a support container including a support on which the roasting plate is placed and supported, and an oil collecting part for collecting oil discharged from the upper and lower ribs of the roasting plate.
